(19) United States
(12) Patent Application Publication
(10) Pub. No.: US 2025/0239157 A1
(43) Pub. Date: Jul. 24, 2025

(54) METHOD AND APPARATUS FOR RECOMMENDING A PARKING LOT TO A VEHICLE

(71) Applicants: HYUNDAI MOTOR COMPANY, Seoul (KR); KIA CORPORATION, Seoul (KR)

(72) Inventor: Jun Soo Kim, Seoul (KR)

(73) Assignees: HYUNDAI MOTOR COMPANY, Seoul (KR); KIA CORPORATION, Seoul (KR)

(21) Appl. No.: 18/678,011

(22) Filed: May 30, 2024

(30) Foreign Application Priority Data
Jan. 19, 2024 (KR) 10-2024-0008754

(51) Int. Cl. G08G 1/14; B60W 30/06; B60W 60/00

(52) U.S. Cl. CPC G08G 1/143; B60W 30/06; B60W 60/001; G08G 1/145

(57) ABSTRACT

A method and an apparatus for recommending a parking lot to a driver using automatic parking are disclosed. The method includes an update process of generating a list of candidate parking lots among parking lots around a current location of the driver based on driver-related information and vehicle-related information. The method also includes a recommendation process of classifying information about the candidate parking lots included in the list of candidate parking lots according to at least one of requirements of the driver or the vehicle-related information and providing the information to the driver. The method also includes a destination setting process of setting the parking lot selected by the driver as a destination of a vehicle.

### CROSS-REFERENCE TO RELATED APPLICATION

This application claims priority to Korean Patent Application No. 10-2024-0008754, filed on Jan. 19, 2024 in the Korea Intellectual Property Office, the entire contents of which are incorporated herein by reference.

### TECHNICAL FIELD

The present disclosure relates to a method and an apparatus for recommending a parking lot to a driver using automatic parking.

### BACKGROUND

The contents described below merely provide background information related to the present disclosure and do not constitute prior art.

Automatic parking is a service that moves a car from the road to a parking space without human intervention.

Typically, when using an automatic parking service, a driver uses a randomly selected parking lot near the destination.

In conventional parking lot information providing services, parking fee information, discount coupon information, etc. are merely provided. Therefore, it is difficult for a driver to obtain information about indoor and outdoor parking and available services after parking, such as availability of car washing and availability of maintenance, in addition to parking availability and parking fees.

### SUMMARY

The present disclosure provides a method and an apparatus for providing parking lot information based on the requirements of a driver using automatic parking services or information related to a vehicle.

The objects to be achieved by the present disclosure are not limited to the objects mentioned above, and other objects not mentioned should be clearly understood by those having ordinary skill in the art from the description below.

According to an embodiment, the present disclosure provides a method of recommending parking lots to a driver using automatic parking. The method includes an update process of generating a list of candidate parking lots among parking lots around a current location of the driver based on driver-related information and vehicle-related information. The method also includes a recommendation process of classifying information about the candidate parking lots included in the list of candidate parking lots according to at least one of requirements of the driver or the vehicle-related information and providing the information to the driver. The method also includes a destination setting process of setting the parking lot selected by the driver as a destination of a vehicle.

According to another embodiment, the present disclosure provides an apparatus for recommending parking lots. The apparatus includes at least one memory in which instructions are stored and at least one processor. The at least one processor is configured to generate a list of candidate parking lots among parking lots around a current location of a driver based on driver-related information and vehicle-related information. The at least one processor is also configured to classify information about the candidate parking lots included in the list of candidate parking lots according to at least one of requirements of the driver or the vehicle-related information and provide the information to the driver. The at least one processor is also configured to set the parking lot selected by the driver as a destination of a vehicle.

According to one embodiment of the present disclosure, a candidate parking lot can be recommended in consideration of the driver's convenience or purpose through communication with the driver using the automatic parking service. The driver can benefit from the increased convenience and time savings by using recommended parking lots without having to search for parking lot information on his own.

According to one embodiment of the present disclosure, a candidate parking lot can be recommended by prioritizing some of the services provided by surrounding parking lots based on the driver's requirements or vehicle-related information.

According to one embodiment of the present disclosure, when the driver selects no candidate parking lot, the search range can be expanded to recommend a candidate parking lot again.

The effects to be obtained by the present disclosure are not limited to the effects mentioned above, and other effects not mentioned should be clearly understood by those having ordinary skill in the art from the description below.

### BRIEF DESCRIPTION OF THE DRAWINGS

FIG. 1 is a block diagram schematically showing a system for a parking lot recommendation service according to one embodiment of the present disclosure.

FIG. 2 is a block diagram schematically showing a parking lot recommendation device according to one embodiment of the present disclosure.

FIG. 3 is a flowchart showing a method of providing a parking lot recommendation service according to one embodiment of the present disclosure.

FIGS. 4A-4E are diagrams showing a process of displaying the method of providing a parking lot recommendation service according to one embodiment of the present disclosure.

FIGS. 5A, 5B, and 5C are diagrams showing various examples of screens on which the method of providing a parking lot recommendation service is displayed according to one embodiment of the present disclosure.

FIG. 6 is a flowchart for explaining a parking lot recommendation method according to one embodiment of the present disclosure.

FIG. 7 is a block diagram schematically showing an exemplary computing apparatus that can be used to implement the method to the present disclosure.

### DETAILED DESCRIPTION

Hereinafter, embodiments of the present disclosure are described in detail with reference to the accompanying drawings. In the following description, like reference numerals designate like elements, although the elements are shown in different drawings. Further, in the following description of some embodiments, a detailed description of known functions and configurations incorporated therein has been omitted for the purpose of clarity and for brevity.

Additionally, various terms such as first, second, A, B, (a), (b), etc., are used solely to differentiate one component from the other but not to imply or suggest the substances, order, or sequence of the components. Throughout the present disclosure, when a part ‘includes’ or ‘comprises’ a component, the part is intended to further include other components and not intended to exclude other components unless specifically stated to the contrary. The terms such as ‘unit’, ‘module’, and the like refer to one or more units for processing at least one function or operation, which may be implemented by hardware, software, or a combination thereof. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

The following detailed description, together with the accompanying drawings, is intended to illustrate embodiments of the present disclosure and is not intended to represent the only embodiments in which the disclosure may be practiced.

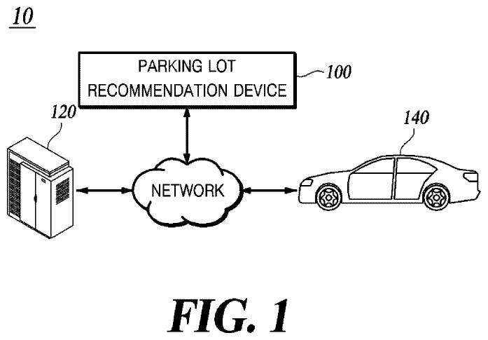

FIG. 1 is a block diagram schematically showing a system 10 for a parking lot recommendation service according to one embodiment of the present disclosure.

As shown in FIG. 1, the system 10 for a parking lot recommendation service according to one embodiment of the present disclosure includes a parking lot recommendation device 100, a server 120, and a vehicle 140.

The parking lot recommendation device 100 may be connected to the server 120 and/or the vehicle 140 through a wireless network to exchange data with each other. The parking lot recommendation device 100 may store and manage information collected from the server 120 and/or the vehicle 140.

The vehicle 140 is a transportation means for transporting a driver to a drop-off location, and may be an autonomous vehicle. The vehicle 140 may be an internal combustion engine vehicle or an electric vehicle.

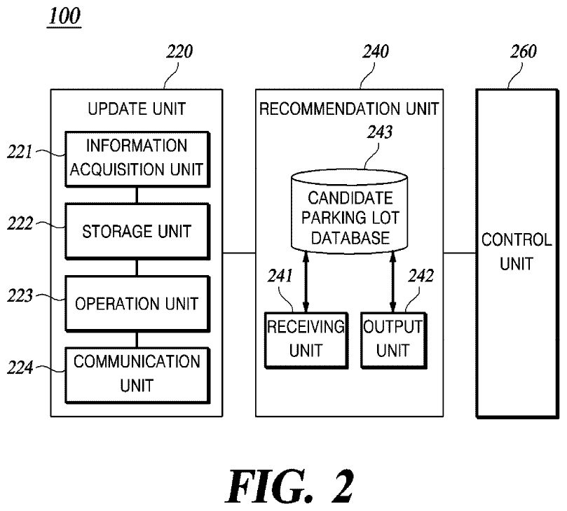

FIG. 2 is a block diagram schematically showing the parking lot recommendation device 100 according to one embodiment of the present disclosure.

As shown in FIG. 2, the parking lot recommendation device 100 according to one embodiment of the present disclosure includes an update unit 220, a recommendation unit 240, and a control unit 260.

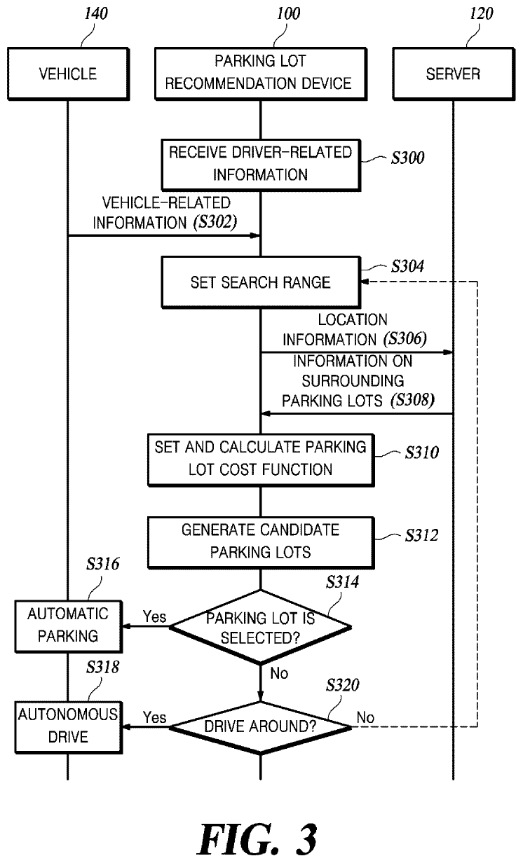

The update unit 220 may include all or some of an information acquisition unit 221, a storage unit 222, an operation unit 223, or a communication unit 224. Not all of the blocks shown in FIG. 3 are essential components, and at least one component may be implemented in an integrated form in an actual physical environment.

The information acquisition unit 221 may obtain driver-related information input from a driver of the vehicle 140 and may receive vehicle-related information from the server 120. The driver-related information may include part or some of the driver's location information or the driver's requirements. The vehicle-related information may include vehicle identifier, vehicle fuel type, vehicle status, vehicle inspection cycle, etc. In the case of electric vehicles, the remaining battery capacity may be included. The inspection cycle may include a car wash cycle or a maintenance cycle.

The storage unit 222 may store the driver-related information and/or the vehicle-related information obtained by the information acquisition unit 221.

The operation unit 223 may generate a list of candidate parking lots among surrounding parking lots located within a search range from the current location of the driver. The search range may include arbitrary values preset by the driver. When generating the list of candidate parking lots, a preset parking lot cost function may be used. The parking lot cost function is a function of one or more of vehicle-related information, parking fees, distance to the surrounding parking lot, travel time to the surrounding parking lot, congestion of the surrounding parking lot, availability of indoor and outdoor parking, or availability of additional services. The additional services may include car washing services or maintenance services. In the case of an internal combustion engine vehicle, the fuel consumption consumed to travel to the candidate parking lot may be included in the parking lot cost function. In the case of an electric vehicle, the electric vehicle charging fee may be included in the parking lot cost function. In the case of an electric vehicle, the electric vehicle charging method may be included as a function in the parking lot cost function. The parking lot cost function may assign weight to vehicle-related information and/or the driver's requirements depending on the driver's selection.

The communication unit 224 transmits the list of the candidate parking lots generated by the operation unit 223 to the recommendation unit 240.

The recommendation unit 240 may include a candidate parking lot database 243, a receiving unit 241, and an output unit 242.

The receiving unit 241 may receive the list of candidate parking lots from the update unit 220.

The candidate parking lot database 243 may store the list of candidate parking lots. Information about the candidate parking lot in the list of the candidate parking lots may be classified according to the driver's requirements or the vehicle-related information. In this case, the process may include sorting the list of candidate parking lots according to the result of the parking lot cost function.

The output unit 242 provides the list of candidate parking lots to the driver and may be provided as one of various components of an electronic device, such as an automotive display, smart phone, smart watch, tablet, computer, UMPC (Ultra Mobile PC), workstation, net-book, PDA (Personal Digital Assistants), portable computer, or PMP (Portable Multimedia Player), but is limited to the above examples.

The control unit 260 causes the vehicle 140 to autonomously drive toward a location selected by the driver. When the vehicle 140 reaches the input location, the vehicle 140 is stopped and parked at the location under the control of the control unit 260. When the driver does not select a specific location, the vehicle 140 travels around the current location of the driver under the control of the control unit 260.

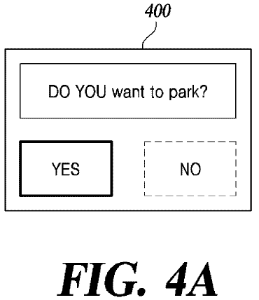

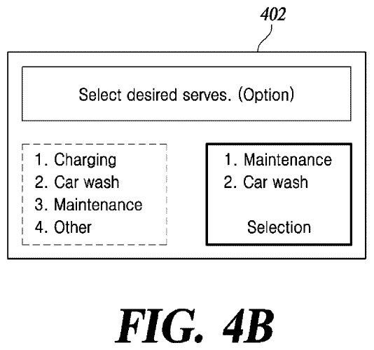

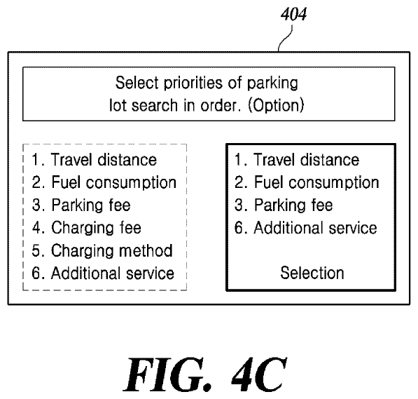

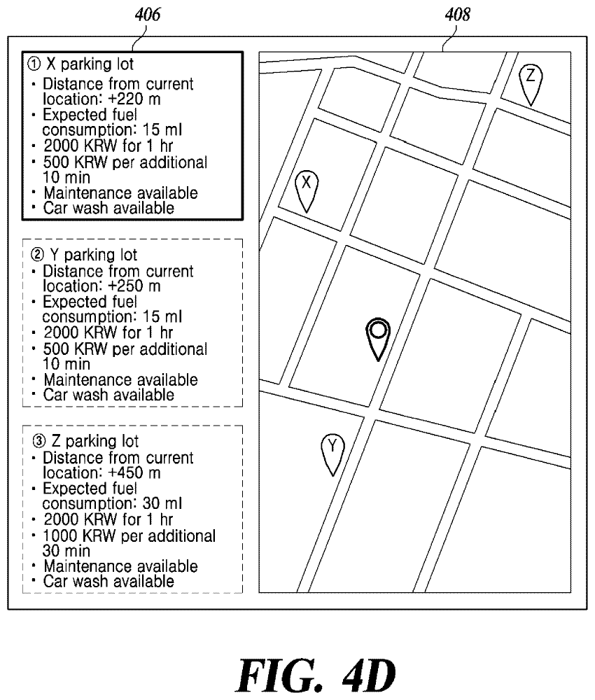

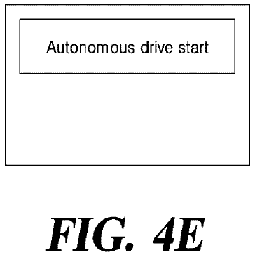

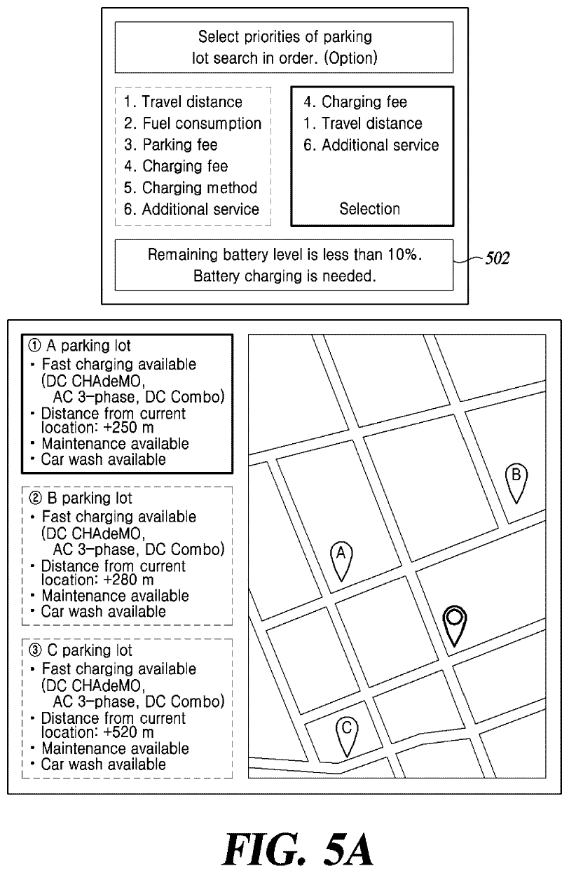

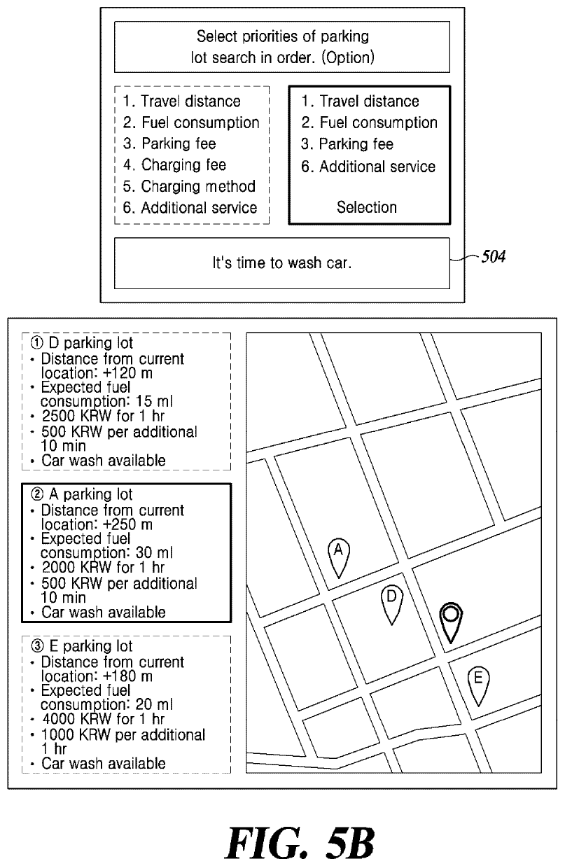

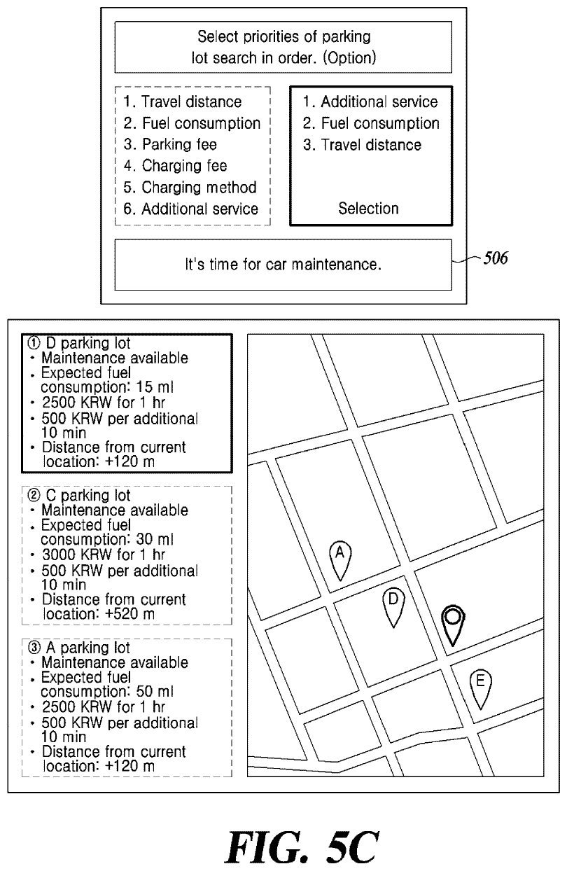

FIG. 3 is a flowchart showing a method of providing a parking lot recommendation service according to one embodiment of the present disclosure. FIGS. 4A-4E are diagrams showing a process of displaying the method of providing a parking lot recommendation service according to one embodiment of the present disclosure. FIGS. 5A, 5B, and 5C are diagrams showing various examples of screens on which the method for providing a parking lot recommendation service according to one embodiment of the present disclosure is displayed.

A query screen 400 is presented to the driver of the parking lot recommendation device 100 to confirm whether the driver wants to park. When the driver wants to park, driver-related information may be received from the driver (S300). The driver-related information may include the driver's location information or the driver's requirements. The driver may select charging, maintenance, car wash, and other services on a desired service selection screen 402. The driver may set priorities among parking lot details on a priority selection screen 404. The vehicle-related information may be reflected on the priority selection screen 404. For example, when the vehicle 140 is an electric vehicle and the remaining battery level is below a certain value, a remaining battery level screen 502 may be displayed at the bottom to inform the driver that the battery needs to be charged. As another example, when the driver has set a car wash cycle in advance, a car wash cycle notification screen 504 may be displayed at the bottom when the car wash cycle is imminent. As another example, when the driver has set a maintenance cycle in advance, a maintenance cycle notification screen 506 may be displayed at the bottom when the maintenance cycle is imminent.

The parking lot recommendation device 100 may receive the vehicle-related information from the vehicle 140 (S302). For example, the parking lot recommendation device 100 may receive the vehicle identifier, vehicle fuel type, vehicle status, vehicle inspection cycle, etc.

The parking lot recommendation device 100 may set a search range from the current location of the driver (S304). The search range may be selected in advance by the driver.

The server 120 may receive the driver's location information (S306) and may provide information on surrounding parking lots located within the search range (S308). For example, when the search range is set to 2 km, the server 120 may provide information, such as parking fees, distance to surrounding parking lots, the travel time to surrounding parking lots, congestion in surrounding parking lots, availability of indoor and outdoor parking, and availability of additional services for parking lots located within 2 km from the driver's location.

The parking lot recommendation device 100 may set a parking lot cost function based on the driver-related information and/or the vehicle-related information and may calculate the result of the parking lot cost function for the list of surrounding parking lots provided from the server 120 (S310). The parking lot cost function is a function of one or more of the vehicle-related information, parking fees, distance to the surrounding parking lot, travel time to the surrounding parking lot, congestion of the surrounding parking lot, availability of indoor and outdoor parking, or availability of additional services. The additional services may include car washing services or maintenance services. In the case of an internal combustion engine vehicle, the fuel consumption consumed to travel to the candidate parking lot may be included in the parking lot cost function. In the case of an electric vehicle, the electric vehicle charging fee may be included in the parking lot cost function. In the case of an electric vehicle, the electric vehicle charging method may be included as a function in the parking lot cost function. The parking/lot cost function may assign weight to the vehicle-related information and/or the driver's requirements depending on the driver's selection.

The parking lot recommendation device 100 generates a list of candidate parking lots according to the result of the parking lot cost function and provides it to the driver (S312). A display may display a candidate parking lot list screen 406 and a candidate parking lot location screen 408 on a map. On the candidate parking lot list screen 406, information about the desired service selected by the driver may be displayed in a priority order selected by the driver. Referring to FIGS. 5A, 5B, and 5C, for example, when the priority is selected in the order of \textcircled{1} 4 Charging fee, \textcircled{2} 1. Travel distance, and \textcircled{3} 6. Additional service, the charging method, travel distance, and available additional service information may be displayed in the order for each candidate parking lot.

The parking lot recommendation device 100 may determine whether the driver selects a specific parking lot from the list of candidate parking lots provided (S314). When the driver selects a specific parking lot from the list of candidate parking lots provided (Yes in S314), automatic parking can be started (S316). For example, referring to FIG. 4D, when the driver selects parking lot X on the candidate parking lot list screen 406, the parking lot recommendation device 100 sets parking lot X as a destination and causes the vehicle 140 to start autonomous driving. In this case, the driver is notified that autonomous driving has started through a driving start notification screen 410. The parking lot recommendation device 100 causes the vehicle 140 to start automatic parking after the vehicle 140 arrives at the destination.

When the driver selects no specific parking lot from the list of candidate parking lots provided (No in S314), the parking lot recommendation device 100 may request input as to whether the driver agrees to drive around the current location of the driver (S320). When the driver agrees to drive around (Yes in S320), the parking lot recommendation device 100 may cause the vehicle 140 to autonomously drive around the current location of the driver (S318). When the driver does not agree to drive around current location of the driver (No in S320), the parking lot recommendation device 100 may expand the search range and recommend another parking lot.

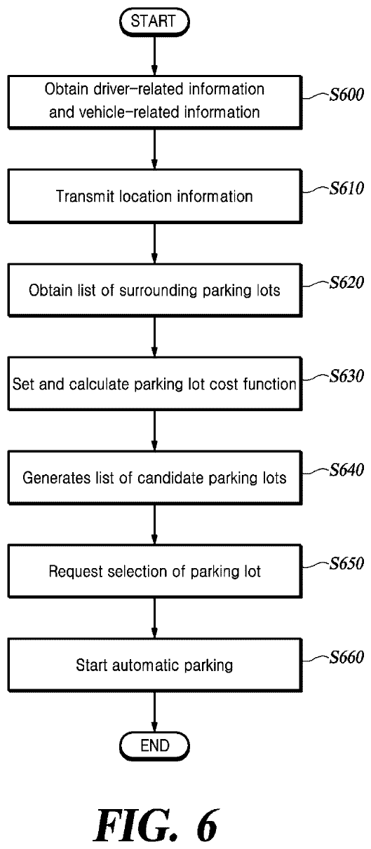

FIG. 6 is a flowchart for explaining a parking lot recommendation method according to one embodiment of the present disclosure.

The method shown in FIG. 6 may be performed by the above-described parking lot recommendation device 100, the server 120, or the vehicle 140 (hereinafter referred to as ‘automatic parking system’). The automatic parking system may secure driver-related information and vehicle-related information (S600). The driver-related information may include driver's location information or driver requirements.

The automatic parking system may transmit the driver's location information to the server 120 (S610) and may generate a list of surrounding parking lots located within the search range from current location of the driver (S620).

The automatic parking system may set a parking lot cost function based on driver-related information and/or vehicle-related information and may calculate the result of the parking lot cost function for the list of surrounding parking lots provided from the server 120 (S630). Among the factors that can be functionalized and included in the parking lot cost function, availability of additional services may include availability of car wash service or availability of maintenance service. In case that the vehicle 140 is an internal combustion engine vehicle, the fuel consumption consumed to move to the candidate parking lot may be included in the parking lot cost function. In case that the vehicle 140 is an electric vehicle, the electric vehicle charging fee may be included in the parking lot cost function. In case that the vehicle 140 is an electric vehicle, the electric vehicle charging method may be included in the parking lot cost function as a function. The parking lot cost function may assign weight to the vehicle-related information and/or the driver's requirements depending on the driver's selection.

The automatic parking system generates a list of candidate parking lots according to the result of the parking lot cost function (S640).

The automatic parking system provides the list of candidate parking lots to the driver and requests the driver to select a desired parking lot (S650). A display may display a candidate parking lot list screen and a candidate parking lot location screen on a map. On the candidate parking lot list screen, information about the desired service selected by the driver may be displayed according to a priority order selected by the driver.

When the driver selects a specific parking lot from the list of candidate parking lots provided, automatic parking can be started (S660). When the driver selects no specific parking lot from the list of candidate parking lots provided, the automatic parking system may ask the driver to confirm that the driver agrees to drive around the current location of the driver. When the driver agrees to derive around the current location of the driver, the automatic parking system may cause the vehicle to autonomously drive around the current location of the driver. When the driver does not agree to drive around the current location of the driver, the automatic parking system may expand the search range and may recommend another parking lot.

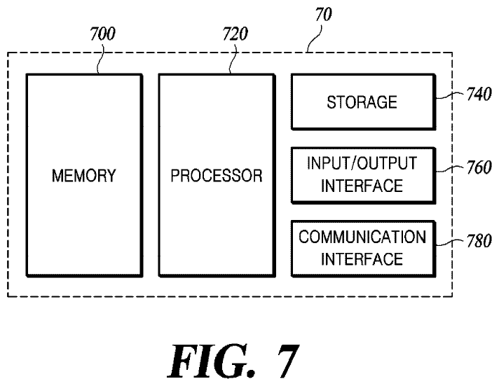

FIG. 7 is a block diagram schematically showing an exemplary computing apparatus that can be used to implement the method according to the present disclosure.

The computing apparatus 70 may include some or all of a memory 700, a processor 720, a storage 740, an input/output interface 760, and a communication interface 780. The computing apparatus 70 may structurally and/or functionally include at least a part of the pick-up location recommendation apparatus 100. The computing apparatus 70 may be a stationary computing apparatus such as a desktop computer, a server, and an AI accelerator, and may be f mobile computing apparatus such as a laptop computer and a smartphone.

The memory 700 may store a program that causes the processor 720 to perform method or operations according to various embodiments of the present disclosure. For example, the program may include a plurality of instructions executable by the processor 720, and the method shown in FIG. 6 may be performed by the processor 720 executing the plurality of instructions.

The memory 700 may be a single memory or a plurality of memories. In this case, information required to perform methods or operations according to various embodiments of the present disclosure may be stored in a single memory or stored in a plurality of memories in a distributed manner. When the memory 700 is configured as a plurality of memories, the plurality of memories may be physically separated.

The memory 700 may include at least one of a volatile memory and a non-volatile memory. The volatile memory includes a static random access memory (SRAM) or a dynamic random access memory (DRAM), and the non-volatile memory includes a flash memory.

The processor 720 may include at least one core capable of executing at least one instruction. The processor 720 may execute instructions stored in the memory 700. The processor 720 may be a single processor or a plurality of processors.

The storage 740 maintains stored data even if power supplied to the computing apparatus 70 is cut off. For example, the storage 740 may include a non-volatile memory or may include storage media such as a magnetic tape, an optical disk, and a magnetic disk.

The program stored in the storage 740 may be loaded into the memory 700 before being executed by the processor 720. The storage 740 may store files written in a program language, and a program created from a file by a compiler or the like may be loaded into the memory 700. The storage 740 may store data to be processed by processor 720 and/or data processed by processor 720.

The input/output interface 760 may include an input device such as a keyboard and a mouse, and may include an output device such as a display device and a printer. A user 122 may trigger execution of a program by the processor 720 and/or check processing results of the processor 720 through the input/output interface.

The communication interface 780 may provide access to external networks. For example, the computing apparatus 70 may communicate with other devices through the communication interface 780.

Each element of the apparatus or method in accordance with the present disclosure may be implemented in hardware, software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

Although operations are illustrated in the flowcharts/timing charts in this specification as being sequentially performed, this is merely a description of the technical idea of one embodiment of the present disclosure. In other words, those having ordinary skill in the art to which one embodiment of the present disclosure belongs may appreciate that various modifications and changes can be made without departing from essential features of an embodiment of the present disclosure, i.e., the sequence illustrated in the flowcharts/timing charts can be changed and one or more operations of the operations can be performed in parallel. Thus, flowcharts/timing charts are not limited to the temporal order.

Although embodiments of the present disclosure have been described for illustrative purposes, those ordinary skill in the art should appreciate that various modifications, additions, and substitutions are possible, without departing from the idea and scope of the claimed invention. Therefore, embodiments of the present disclosure have been described for the sake of brevity and clarity. The scope of the technical idea of the present embodiments is not limited by the illustrations. Accordingly, one of ordinary skill should understand that the scope of the present disclosure should not be limited by the above explicitly described embodiments but by the claims and equivalents thereof.

What is claimed is:

1. A method of recommending parking lots to a driver using automatic parking, the method comprising:
an update process of generating a list of candidate parking lots among parking lots around a current location of the driver based on driver-related information and vehicle-related information;
a recommendation process of classifying information about the candidate parking lots included in the list of candidate parking lots according to at least one of requirements of the driver or the vehicle-related information and providing the information to the driver; and
a destination setting process of setting the parking lot selected by the driver as a destination of a vehicle.

2. The method of claim 1, wherein the update process includes updating a preset parking lot cost function, and
wherein the preset parking lot cost function is a function of one or more of the vehicle-related information, parking fee, distance to a surrounding parking lot, travel time to the surrounding parking lot, congestion in the surrounding parking lot, availability of indoor and outdoor parking, or availability of additional services.

3. The method of claim 2, wherein when the vehicle is an internal combustion engine vehicle, fuel consumption consumed to move to the surrounding parking lot is included in the preset parking lot cost function.

4. The method of claim 2, wherein the additional services include at least one of car wash service or maintenance service.

5. The method of claim 2, wherein when the vehicle is an electric vehicle, electric vehicle charging fee is included in the preset parking lot cost function.

6. The method of claim 5, wherein an electric vehicle charging method is included in the preset parking lot cost function as a function.

7. The method of claim 2, wherein the recommendation process includes sorting the list of candidate parking lots according to a result of the preset parking lot cost function.

8. The method of claim 2, further comprising:
assigning, by the preset parking lot cost function, weight to at least one of the vehicle-related information or the requirements of the driver according to a selection of the driver.

9. The method of claim 1, further comprising, when the driver does not select parking lot:
causing the vehicle to drive around the current location of the driver; or
expanding a search range from the current location of the driver; and
recommending another parking lot through the update process.

10. An apparatus comprising:
at least one memory in which instructions are stored; and
at least one processor,
wherein the at least one processor is configured to, by executing the instructions:
generate a list of candidate parking lots among parking lots around a current location of a driver based on driver-related information and vehicle-related information,
classify information about the candidate parking lots included in the list of candidate parking lots according to at least one of requirements of the driver or the vehicle-related information,
provide the information to the driver, and
set the parking lot selected by the driver as a destination of a vehicle.

11. The apparatus of claim 10, wherein the at least one processor is further configured to update a preset parking lot cost function, and
wherein the preset parking lot cost function is a function of one or more of the vehicle-related information, parking fee, distance to a surrounding parking lot, travel time to the surrounding parking lot, congestion in the surrounding parking lot, availability of indoor and outdoor parking, or availability of additional services.

12. The apparatus of claim 11, wherein when the vehicle is an internal combustion engine vehicle, fuel consumption consumed to move to the surrounding parking lot is included in the preset parking lot cost function.

13. The apparatus of claim 11, wherein the additional services include at least one of car wash service or maintenance service.

14. The apparatus of claim 11, wherein when the vehicle is an electric vehicle, electric vehicle charging fee is included in the preset parking lot cost function.

15. The apparatus of claim 14, wherein an electric vehicle charging method is included in the preset parking lot cost function as a function.

16. The apparatus of claim 11, wherein the at least one processor is further configured to sort the list of candidate parking lots according to a result of the preset parking lot cost function.

17. The apparatus of claim 11, wherein the preset parking lot cost function assigns weight to at least one of the vehicle-related information or the requirements of the driver according to a selection of the driver.

18. The apparatus of claim 10, wherein when the driver does not select parking lot, the at least one processor is further configured to:
cause the vehicle to drive around the current location of the driver, or
expand a search range from the current location of the driver and recommend another parking lot through generating a list of candidate parking.
